(19) United States
(12) Patent Application Publication
(10) Pub. No.: US 2015/0060154 A1
(43) Pub. Date: Mar. 5, 2015

(54) METHOD FOR WEIGHING A CAR WITHOUT UNCOUPLING A TRAINSET

(71) Applicant: Aleksandr Viktorovich PASHHENKO, Armavir (RU)

(72) Inventor: Aleksandr Viktorovich Pashhenko, Armavir (RU)

(21) Appl. No.: 14/390,867

(22) PCT Filed: Dec. 11, 2012
(86) PCT No.: PCT/RU2012/001052

§ 371 Date: Oct. 6, 2014

(30) Foreign Application Priority Data
Apr. 5, 2012 (RU) 2012118083

(51) Int. Cl. G01G 19/04

(52) U.S. Cl. CPC G01G 19/045
USPC 177/1

(57) ABSTRACT

The invention relates to measurements, and specifically to devices for weighing movable trainsets and units thereof without uncoupling said trainsets. The method for weighing a car without uncoupling a trainset is characterized by the use of weighing sections comprising weight-measuring devices, wherein, for the assessment of the weight of the car being weighed, weight data are collected only from those weighing sections on which the wheels of the car being weighed are standing, wherein the weighing sections are mounted consecutively in a section of the railroad track in such a way that the car being weighed is arranged on said weighing sections with all of its wheels, while the wheel pairs of each neighbouring car which is coupled to the car being weighed do not touch the sections involved in the weighing.

### The invention relates to measurements, specifically to devices for weighing movable trainsets and units thereof.

Known trainset scales, containing control sections of the track, are mounted on parallel load-bearing beams, which lean on the tension gauges (U.S. Pat. No. 5,308,933 A, May 3, 1994). In this device, the length of the control track sections (of the weighing section) is equal or slightly greater than the base length of the measured object, so that for measuring weight (mass) the object is positioned on the control section of the track. A disadvantage of this technical solution is limited functionality due to its ability to weigh either uncoupled transport vehicles, for example train cars, or coupled vehicles of only one length corresponding to the weighing platform.

A known patent RU2287137 for a method of weighing moving railway objects, comprising measurement of the present value of the force acting on the rails through the wheels of the railroad object being weighed, characterized by performing measurements while the railroad object being weighed is in motion along uncut rail of standard length, wherein the current value of the force acting through the wheels of the weighed railway object is measured on one point of each rail with a vertically mounted weight gauge as the wheels of the weighed object pass through the point section of rail, fixing the maximum value of function P=f(t), where P—current value of force, t—time, summarizing the values of all fixed maximum values of function P=f(t).

This method allows the weight measurement of each traincar axle individually, but does not solve the problem of simultaneously weighing all axles of the transport vehicles without uncoupling, which does not permit weighing liquid cargo.

Known patent RU91424U for SCALES FOR WEIGHING AUTOMOBILES AND TRACTOR-TRAILERS. The proposed scales for weighing cars and trains comprise a successively arranged entry ramp, even number of weighing platforms with load-bearing planes and exit ramp, adjacent to the corresponding flat ramp sections of the platform arranged on one level with flat load-bearing surfaces of the base weighing platform, with weight-measurement gauges mounted on the support sections of the foundation, on which rest the weighing platforms, processing unit for weight measurement results, processing and display unit for weight measurement results, with one input connected to the weight-measuring gauge, four additional weight-measuring gauges, and an additional weighing platform, which is positioned between the main weighing platforms and resting on four additional weight-measuring gauges, which are mounted on the weighing platforms adjacent to the additional weighing platform and connected to the input of the processing unit for weighing results, which determines the weight as a sum of measured values. The output from this unit is connected to another input for a processing and display unit for the weight-measuring results.

The stated ratio of device sizes allows the positioning of the weighed transport vehicle—car or train—to be on the horizontal surface H at all times, which is necessary for obtaining an accurate measurement. The position of the additional weighing platform 14 is symmetrical with respect to the weighing platforms 3,4,5, 6, which permits weighing of the transport vehicles (train 1) when entering from either side of the scale. The technical solution describes a process of weighing axle by axle, although for an automobile. When using scales for weighing train cars it is impossible to weigh the whole trainset and therefore impossible to weigh liquid cargo, in principle.

A known scale according to patent RU2390735 C1, May 27, 2010, comprised of two weight-measuring sections and a non-weight-measuring section (inserts), which form a section of railroad track, mounted on the ground between two weight-measuring sections.

The weighing sections are installed in the rail track with ties. However, this scale design limits functionality when weighing moving trainset and its individual units of varying wheelbases resulting from the latter simultaneously positioning onto the weighing section and the rail sections, which are attached to the ground. Thus the possibility arises that there may be other units of the trainset on the weighing section than the one being weighed.

The closest art are the Train scales 7260 RAILMATE for weighing railroad trains [1]. The weighing platform of the traincar scales is made of solid load-bearing modules, installed in the pit. The modular design of the train scales provides simple installation without the use of welding. The modules have the ability to expand and contract during temperature changes and applied loads. During servicing of the train scales, access to all components is through movable panels. Design and dimensions of the load-bearing platform on the train scales is determined by weighing train fleets and tankers, which are to be weighed on the scale. In order to weigh special means of transport (for example, during metallurgical production) it is possible to produce train scales for each individual project.

When weighing in motion the specialized software determines the moment of weighing, records the weight information from the weight gauge and sums up the weight results [2].

A method for weighing traincars of the specified weights, 7260 RAILMATE is characterized by the use of weighing sections on which weight-measuring devices are located. In order to determine the weight of the car being weighed, weight data is collected cumulatively only from the weighing sections on which the wheels of the car being weighed are standing. The weighing sections are installed in series in a cut of railroad track such that the car being weighed is positioned on them with all wheels, while the sections not used for weighing are not touching the wheel pairs of each following car connected to the car being weighed.

The disadvantage of the stated method is the instance, known in over 200 types of tankers used for transporting liquid cargo, where it is necessary to weigh the whole trainset (with the train having all wheels on the load-bearing device). Traincar wheelbases vary between 7,120 on 4-axle to 16,670 on 8-axle tankers. Scales for this type of weight-measurement comprise independent, sufficiently long platforms, which do not permit (without uncoupling) positioning the car on the weighing platform such that the neighboring cars are not the same platform. Technically part of the cars may be placed on the weighing platform without uncoupling such that the neighboring car does not enter it, but due to the small tolerance in car positioning (where exceeding it causes the car to either roll off the weighing platform or the next car to ride onto it) securing them in a position where they can be weighed is very labor-intensive, due to the great inertia of the cargo.

Technical result of the invention is the ability to take weight (mass) measurements of railway trainsets without uncoupling and with a larger tolerance for car positioning, wherein the cars comprise varying types of trainset units (cars) with different wheelbases, including cars with liquid cargo (tankers).

The claimed technical result is achieved by the method for weighing cars without uncoupling the railroad trainset, characterized by using weighing sections comprising weight-measuring devices, wherein, for the assessment of the weight of the car being weighed, weight data are collected only from those weighing sections on which the wheels of the car being weighed are standing, wherein the weighing sections are mounted consecutively in a section of the railroad track in such a way that the car being weighed is arranged on said weighing sections with all of its wheels, while the wheel pairs of each neighbouring car coupled to the car being weighed do not touch the sections involved in the weighing, and said method is characterized by the lengths of the weighing sections which are selected such that, as the trainset passes through the weighing sections, for each car in a time interval assigned to the measurement of the weight of the car, one or more weighing sections are used on which, in the said time interval, only the wheel pairs of the car being weighed are found.

When the wheel(s) of the weighed car are standing at a junction between different weigh sections, both section are used for measuring the weight of the car.

At least one of the weighing sections has a length no greater than L, which corresponds to the minimum length of a segment from all segments connecting the closest edges of the contact points of adjacent wheel pairs to each other, from the coupled cars of the whole trainset that is being weighed.

The weighing sections have length no greater than L and are installed in series along the segment of railway track.

Additionally, weighing sections with length no greater than 2L in series along the segment of railway track are installed.

Additionally, weighing sections with length greater than L in series along the segment of railway track are installed.

Additionally, at least one non-weighing section is placed between the weighing sections along the railway track.

### DESCRIPTION OF THE FIGURES

FIG. 1 illustrates a schematic embodiment of the method using several weighing sections of varying length.

FIG. 2 illustrates a schematic view of an estimated, theoretically possible maximum length for weighing section L (14), without accounting for factors that influence the effect of the wheel pairs positioned near the border of a specified weighing section (snow, sand, rocks on the surface of weighing section, possible sag in weighing section, etc) on the weighing section.

### PREFERRED EMBODIMENTS

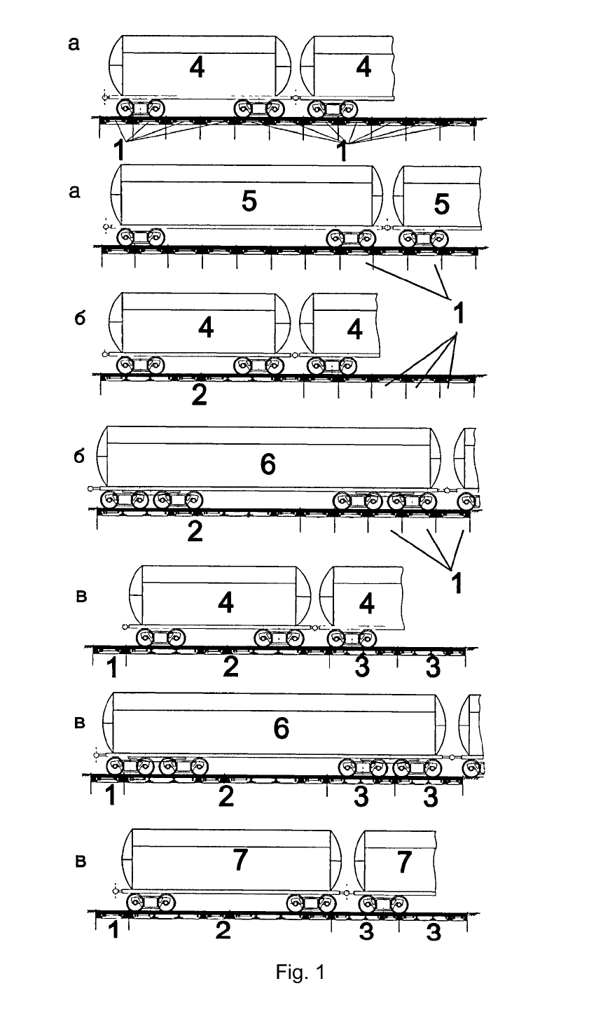

Method may be implemented as follows. Scales for weighing railroad trainsets comprise weighing sections. In certain embodiments, at least one of the weighing sections is made of a determined length L (14) and equipped with a measuring device (see FIG. 1). Weighing sections are installed in series in the railroad track such that any car in a trainset can be positioned on the weighing device without uncoupling or the next attached car getting on the weighing section.

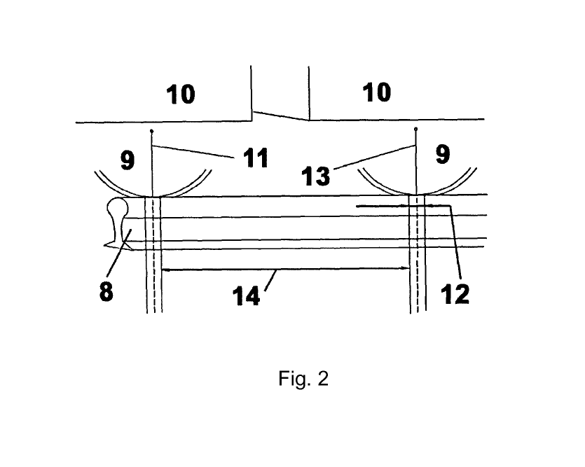

This can be implemented by having a number of weighing sections such that the car with the largest distance between the first axle (11) of the first wagon and the last axle (13) of the second wagon always fits freely on the series of weighing sections. In certain scale embodiments, at least one of the weighing sections has a length no greater than L (14), connecting the closest edges of the contact points of adjacent wheel pairs (9) of the coupled cars (10) to each other (see FIG. 2).

Thus any car may, without uncoupling the trainset, be positioned on a weighing section so that the next car coupled to him does not get on the weighing section. For example, scales can have additional non-weighing sections adjacent to the first weighing section that serve as part of the railway track that is mounted in the ground and an additional weighing section installed before the non-weighing section. In this embodiment the amount of weighing sections can be decreased due to the combined length of the additional weighing and non-weighing sections. The weight of the car is determined by summing the weight readings from the weighing sections on which the car being weighed is positioned. The direction the trainset enters the scale for weighing cars can occur from either side. Consider that each weighing section equals, for example, 2 meters, drawing on known traincar characteristics. The car being weighed has to keep all wheels on the weighing sections. Neighboring cars entering the scale will not influence the results of the weighing since no power will be allocated to these weighing sections, occupied by the neighboring cars. No data are used for determining the car weight from the weighing sections that touch the wheel pairs of every following car coupled to the car being weighed.

The claimed scales can also have a non-weighing section connected to the first weighing section, which forms a part of the railroad track, with additional weighing sections installed before the non-weighing section. In this embodiment, the amount of weighing sections can be decreased due to the combined length of additional weighing and non-weighing platforms. The given embodiment also permits weighing all known types of cars without uncoupling along the whole wheelbase and has higher precision because the first train wagon is always on a single, additional lengthy weighing section (2), instead of a row of short weighing sections (1). This way, the first car wagon is always positioned on an additional weighing (long) section (2), and the second wagon is in any position on the weighing sections (1) (2-meter sections). It is recommended that the length of the non-weighing section not exceed the minimum wheelbase of the car being weighed with the shortened length of weighing section and length of contact points of the car wheels with the rail. It is envisioned that additional weighing sections may be implemented of a length no less than the distance between the outer axles (11, 13) of the car wagon increased to the size of contact points (12) between the car wheels (9) and rail (8).

A method of weighing can be embodied, for example, as follows:

Scales for weighing trainsets comprise weighing sections (1) arranged in series, of a certain length no less than L (14). To determine L from the variety of cars that are found in the trainset being weighed (in the embodiment, if cars are arbitrarily positioned in the trainset), a model traincar (4) with minimum length of horizontal projection, a segment extending from the center of the coupling to the nearest axle of wheel pairs from the same car. The maximum possible length of weighing section (1) is equal to the maximum possible for a weighing section where every adjacent wheel pair (9) belonging to two different coupled wagons (10) of this model would not be simultaneously loaded on the weighing section. When meeting this condition for weighing it is sufficient to have car being weighed positioned on the weighing section with all of its wheel pairs. All sections loaded with the weighed car are used in the summation when determining the weight of the car. Preceding and following cars, coupled to car being weighed, by definition cannot be loaded on to the weighing sections that are loaded with the weighed car.

Although the aforementioned application of the weighing method is useful for small requirements in positioning the car being weighed (it is necessary and sufficient for the weighed car to have all of its wheels standing on the weighing section of length no less than L), the given embodiment for building scales, although it best describes the use of the stated weighing method it is an expensive one, since it requires using sufficiently large quantities of weighing sections in the scale design. There are more economical ways to implement a continuous series of weighing sections for weighing cars using their total wheelbase. Below is one of the possible embodiments of the weighing method using a series of weighing sections:

In the case where the car being weighed can be positioned by the left (right, front, back—at your discretion) car wagon on a certain place (for the variant when weighing stationary cars without uncoupling the whole wheelbase), then a weighing system using the given weighing method can be built as follows:

Position on the left side of the scales one or several weighing sections (among them may be a non-weighing section(s), in place(s) where wheels from the weighed car would not be located during the moment of weighing) of length greater than L, positioned in such a way that the shorter 4-axle cars can (with a sufficient degree of freedom) be arranged on them without risk of the previous or following coupled cars riding onto the weighing sections. For example, if the minimum distance between the first and last car axle (from the first car being weighed) is equal to 9 meters, and L is equal to 2 meters, then it is reasonable to use two weighing sections with a total length of 11 meters.

To ensure the first car is positioned strictly on the first weighing section, it is possible (for example) for the first weighing section to have length equal to the wheelbase of the 4-axle wagon+L, approximately 7 meters, and the following weighing section to be 4 meters. Further after them, position a series of sections having length less than L, on which the longer cars will be weighed. In this embodiment of scale design the first 5-6 weighing platforms have length less than L (in practice, L is approximately 2 meters), which increases the accuracy of the scales due to decreased amount of weighing sections participating in the weighing, since the first wagon of the train being weighed is on weighing section number one (7-meter). The second wagon of a significant amount of 4-axle short-wheelbase will be on weighing section number 2. This embodiment of implementing the weighing method is also cheaper due to the decreased number of weighing sections.

Consider the case of building a weighing system, comprised of weighing sections with length no greater than L, excluding even the partial encroachment on one section of two coupled cars at once (the length of the weight section is within the minimal possible length of the segment connecting the contact points of the neighboring cars, which can be in this series).

When examining the number of tanker trains used, for example, on Russian Railroads, then (1) for the whole tanker pool, 2 meters can be tentatively used (further for convenience of presenting information we use the assumption that L can be greater than 2 meters, and 2L, respectively, more than 4 meters), and (3) also it can be tentatively set at 4 meters.

Thus, if we have a weighing system in the form of a series of a multitude of installed weighing sections (1) (see FIG. 1(a)), then regardless of what position the car (4) is in (under the condition that all wheels are on the weighing sections), it occupies the weighing sections which a priori cannot be occupied by any of the cars coupled to it.

From a comfort perspective, using the given embodiment is preferable: it involves only location conditions of the whole train being weighed on the series of weighing sections. A possible drawback of this embodiment with a large number of weighing sections is the practical implementation of it may lead to significant increases in scale costs and certain decreases in measurement precision.

To eliminate this shortcoming, and taking into account:
convenience of positioning the car during static weighing
length of time available for positioning the car on the weighing sections for dynamic weighing can be applied, for example, to the following embodiments of designing a series of 2-meter-long weighing sections (1) and one longer weighing section (2), for example, 12 meters (see FIG. 1(b)).
in this embodiment of the scales (instead of 12-meter weighing sections, for example—two six meter weighing sections can be used), weighing the whole train wheelbase is possible only under the following conditions:
   a) the shortest cars (4) should be weighed on the long (2) section; in this case it is necessary to make sure the neighboring coupled cars are not on the weighing section, nor on the right series of weighing sections (1); in this case it is necessary to keep the whole car on the series of weighing sections (1).
   b) longer cars (5,6) are weighed using 12 meter platforms, involving the series of weighing sections (1) by positioning the wagons of the car being weighed at the left side of the 12-meter weighing section (2), thus, the wheel pairs of the neighboring car stay off the weighing sections; the right wagon of the car being weighed is in this case is placed in the series of weighing section (1) and, consequently, does not require additional positioning (the longest cars need to be monitored so they do not come off the right series of weighing sections).

In this embodiment (see FIG. 1(c)) of scales the placement of sections implemented using sections (1,2,3) (use of two 6-meter weighing sections is permitted instead of the 12-meter section) weighing the whole car wheelbase is possible only under the following conditions:
the shortest cars (4, 7) are weighed using 12-meter sections (2), either on the series of weighing sections (3) having length greater than 2L and requiring control to prevent wheel pairs of the neighboring coupled car from getting on the specified weighing section(s) during weighing;
longer cars (5, 6) that do not entirely fit on the long section (2) are weighing on combinations of weighing sections (1,2,3): 1+2; 2+3; 1+2+3, 2+3+3, 1+2+3+3, as the distance between the outer axles of the car, requiring control to prevent wheel pairs of the neighboring coupled car from entering (just as in previous cases, so in successive). If ease of use when positioning the car is not important, then the section (1), with length less than L, can be enlarged to 2L, and section (3) to 4L (though increased section length complicates the positioning of the car on the weighing sections so that it is the only one on it).

Also consider the properties of a series of weighing section with length lying between L and 2L. In this case, it is necessary to take into account that the more the length of the weighing section exceed L and approaches 2L, the more difficult it will be to position the cars for the purpose of weighing (the less time there will be to obtain data when the car being weighed is dynamic). The unconditional ability to weigh static cars regardless of their car positioning on the weighing series (continuity of data gathering, necessary for calculating weight when the car is dynamic), under the condition of having all car wheels on the weighing platform, is clearly absent here.

Throughout the stated description weighing cars in static or dynamic states using the combined wheelbase was mentioned, since car-by-car weighing (suitable for non-liquid and viscous cargo) on the examined weighing systems present a trivial problem.

It is also assumed that when the car wheels are on a junction between two weighing sections, weighing the car wheels is also possible by taking into account weighing data from both sections, since the absence of this ability creates significant inconvenience when using the scales due to the added requirement that wheels on the car being weighed are not on the junction between weighing sections.

The maximum length of a single weighing section L (14) is equal to the length of segment connecting to each other the closest contact points (12) of adjacent wheel pairs (9) of cars coupled together (10) (see FIG. 2). When planning the length of the weighing sections, the design of the scales and conditions of functionality less than L are taken into account.

Consider the possibility of designing a series of weighing sections with lengths L to 2L. The series of individual weighing section having length less than 2×L, but more than L is also suitable for separating the weights of different cars onto different weight-measuring devices. However, it is not unconditional since it depends on the position of the car on the weighing series.

The longer the individual weighing section, having length between L and 2×L, included in the weighing series, the more difficult it will be to position the car being weighed in such a way that the neighboring cars do not enter the weighing sections that are occupied by the car being weighed.

Similarly in the series of weighing sections in those intervals where, during all types of weighing, it is impossible to position the wheel pairs of the car being weighed such that they allow the use of non-weighing sections, due to economic feasibility.

Therefore it is preferable to use such sets of weighing sections where at least one always has length no greater than L for facilitating the car positioning.

When selecting the length of weighing sections it is necessary to avoid significantly reducing them to avoid increasing cost of the weighing system as well as keep it from approaching L to avoid generating errors. If the cost of the scales, depending on whether the number of weight-measuring sections have primary importance and if the ability to position the car in a position suitable for weighing on the first time is irrelevant, then it is preferable to use sections larger than L, taking into account the ability to place the car in a position suitable for weighing.

For weighing dynamically, it is also important for the weighing section to have length less than L, but greater than the maximum distance between the outer edges of the contact points of the outer axles of 4-axle car wagon suitable for a sensor, showing the end of one car and the start of

another (the platform weight indicators temporarily pass zero).

Also, in all preceding description of implementations of the method it is assumed that the cars in the trainset are arranged randomly and all are subject to weighing (this depends on the method used for determining L).

### INFORMATION SOURCES

1. ru.mt.com/ru/ru/home/products/Transport_and_Logistics_Solutions/rail_scales/st atic_rail_scale/7260_RAILMATE_Railroad_Scales.html

2. http://ru.mt.com/ru/ru/home/products/Transport_and_Logistics_Solutions/rail_sca les/static_rail_scale/7260_RAILMATE_Railroad_Scales.html

What is claimed is:

1. A method for weighing a car without uncoupling a trainset, characterized by the use of weighing sections, comprising: weight-measuring devices, wherein, for an assessment of a weight of the car being weighed, a weight data is collected only from those weighing sections on which wheels of the car being weighed are standing, wherein the weighing sections are mounted consecutively in a segment of a railroad track in such a way that the car being weighed is arranged on said weighing sections with all of its wheels, while wheel pairs of each neighbouring car coupled to the car being weighed do not touch the sections involved in the weighing, and said method is characterized in that lengths of the weighing sections are selected such that, as the trainset passes through the weighing sections, for each car in a time interval which is assigned to a measurement of the weight of the car, one or more weighing sections are used on which, in said time interval, only the wheel pairs of the car being weighed are found.

2. The method according to claim 1, characterized by a use of both weighing sections when the wheel(s) of the weighed car are standing at a junction between different weigh sections.

3. The method according to claim 1, characterized by at least one of the weighing sections having a length no greater than L, which corresponds to a minimum length of a segment from all segments connecting a closest contact point edges of adjacent wheel pairs to each other, from coupled cars of the whole trainset that are being weighed.

4. The method according to claim 1, characterized by the weighing sections, with length no greater than L, installed in series along a segment of a railway track.

5. The method according to claim 1, characterized by additionally installing weighing sections with length no greater than 2L in series along the segment of railway track.

6. The method according to claim 1, characterized by additionally installing weighing sections with length greater than L in series along the segment of the railway track.

7. The method according to claim 1, characterized by additionally arranging at least one non-weighing section between the weighing sections along the railway track.

8. The method according to claim 4, characterized by additionally installing weighing sections with length greater than L in series along the segment of the railway track.

9. The method according to claim 5, characterized by additionally installing weighing sections with length greater than L in series along the segment of the railway track.

10. The method according to claims 4, characterized by additionally arranging at least one non-weighing section between the weighing sections along the railway track.

11. The method according to claims 5, characterized by additionally arranging at least one non-weighing section between the weighing sections along the railway track.

12. The method according to claims 6, characterized by additionally arranging at least one non-weighing section between the weighing sections along the railway track.
